(19) United States
(12) Patent Application Publication
(10) Pub. No.: US 2024/0402697 A1
(43) Pub. Date: Dec. 5, 2024

(54) Industrial Batch Dataset Generation for Operations Modeling

(71) Applicant: Rockwell Automation Technologies, Inc., Mayfield Heights, OH (US)

(72) Inventors: Meiling He, Shorewood, WI (US); Ankan Chowdhury, Pune (IN); Scott W. Stevens, Troy, MI (US); John Hatzis, Marlboro, MA (US); Fatime Ly Seymour, Charlotte, NC (US); Francisco P. Maturana, Lyndhurst, OH (US)

(21) Appl. No.: 18/679,061

(22) Filed: May 30, 2024

Related U.S. Application Data
(60) Provisional application No. 63/469,684, filed on May 30, 2023.

(51) Int. Cl. G05B 23/02

(52) U.S. Cl. CPC G05B 23/0254; G05B 23/0267; G05B 23/0289

(57) ABSTRACT

A non-transitory tangible, computer-readable medium storing instructions that, when executed by processing circuitry, cause the processing circuitry to perform operations including receiving data associated with industrial equipment, pre-processing the data using pre-processing files associated with a modeling technique to generate pre-processed data, generating training dataset files based on the pre-processed data, and generating a model representative of expected operations of the industrial equipment based on the training dataset files. The instructions cause the processing circuitry to perform operations including storing an association between the training dataset files with the modeling technique, the industrial equipment, or both in a database, receiving a request to generate an additional model representative of additional expected operations of additional industrial equipment, receiving additional data associated with the additional industrial equipment, retrieving the training dataset files based on the additional data, and generating the additional model based on the training dataset files and the additional data.

### CROSS-REFERENCE TO RELATED APPLICATION

This application claims priority to and the benefit of U.S. Patent Application No. 63/469,684, entitled “ANOMALY DETECTION IN INDUSTRIAL BATCH PROCESSING UTILIZIING ARTIFICIAL INTELLIGENCE ENGINES AND INTEGRATION OF IT-OT DATA”, filed May 30, 2023, which is herein incorporated by reference in its entirety for all purposes.

### BACKGROUND

This disclosure generally relates to industrial automation systems and, more particularly, to techniques for efficient data modeling in industrial automation systems.

Industrial automation systems may include automation control and monitoring systems. The automation control and monitoring systems may monitor and/or receive status information and/or sensing data from a wide range of devices, such as valves, electric motors, various types of sensors, other suitable monitoring devices, or the like. In addition, one or more components of the automation control and monitoring systems, such as programming terminals, automation controllers, input/output (IO) modules, communication networks, human-machine interface (HMI) terminals, and the like, may use the status and/or collected information to provide alerts to operators to change or adjust an operation of one or more components of the industrial automation system (e.g., such as adjusting operation of one or more actuators), to manage the industrial automation system, or the like.

Manufacturing processes employed by industrial automation systems may involve using precise outputs. In batch production, an industrial process, such as a manufacturing process of a product, may generate the product in multiple batches. For each batch generated in the industrial process, batch data may be collected and analyzed to determine whether the batch is anomalous (e.g., includes an anomaly). To determine whether the batch is anomalous, some systems may rely on certain testing procedures that may take some amount of time (e.g., days, weeks) to analyze. This may hinder rapid development of products, especially considering that that additional batch processing of new products increases each year. As such, improved systems and methods for detecting anomalies in industrial batch processing systems are desirable. Thus, improved industrial automation system techniques are desirable to facilitate enhanced batch anomaly analysis, while providing more efficient and reliable batch processing.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, a system includes industrial automation equipment of an industrial system and a processing system comprising a memory, the memory encoded with instructions configured to be executed by the processing system to cause the processing system to perform operations including receiving data associated with the industrial automation equipment, pre-processing the data using one or more pre-processing files associated with a modeling technique to generate pre-processed data, generating one or more training dataset files based on the pre-processed data, wherein the one or more training dataset files are representative of one or more operational characteristics of the industrial automation equipment over time, generating a model representative of one or more expected operations of the industrial automation equipment based on the one or more training dataset files, and storing the one or more training dataset files and an association between the one or more training dataset files with the modeling technique, the industrial automation equipment, or both in a database. The operations also include receiving a request to generate an additional model representative of one or more additional expected operations of additional industrial automation equipment of an additional industrial system different from the industrial system, receiving additional data associated with the additional industrial automation equipment, retrieving the one or more training dataset files based on the additional data, and generating the additional model based on the one or more training dataset files and the additional data.

In another embodiment, a non-transitory, tangible, computer-readable medium storing instructions that, when executed by processing circuitry, cause the processing circuitry to perform operations including receiving data associated with the industrial automation equipment, pre-processing the data using one or more pre-processing files associated with a modeling technique to generate pre-processed data, generating one or more training dataset files based on the pre-processed data, wherein the one or more training dataset files are representative of one or more operational characteristics of the industrial automation equipment over time, generating a model representative of one or more expected operations of the industrial automation equipment based on the one or more training dataset files, and storing the one or more training dataset files and an association between the one or more training dataset files with the modeling technique, the industrial automation equipment, or both in a database. The instructions also cause the processing circuitry to perform operations including receiving a request to generate an additional model representative of one or more additional expected operations of additional industrial automation equipment of an additional industrial system different from the industrial system, receiving additional data associated with the additional industrial automation equipment, retrieving the one or more training dataset files based on the additional data, and generating the additional model based on the one or more training dataset files and the additional data.

In yet another embodiment, a method includes receiving, via processing circuitry, data associated with one or more industrial devices of an industrial system, pre-processing, via the processing circuitry, the data using one or more pre-processing files associated with a modeling technique to generate pre-processed data, and generating, via the processing circuitry, one or more training dataset files based on the pre-processed data, wherein the one or more training dataset files are representative of one or more operational characteristics of the industrial automation equipment over time. The method also includes generating, via the processing circuitry, a model representative of one or more expected operations of the industrial automation equipment based on the training dataset files, storing, via the processing circuitry, the one or more training dataset files and an association between the one or more training dataset files with the modeling technique, the industrial automation equipment, or both in a database, and receiving, via the processing circuitry, a request to generate an additional model representative of one or more additional expected operations of additional industrial automation equipment of an additional industrial system different from the industrial system. Further, the method includes receiving, via the processing circuitry, additional data associated with the additional industrial automation equipment, and retrieving, via the processing circuitry, the one or more training dataset files based on the additional data, and generating, via the processing circuitry, the additional model based on the one or more training dataset files and the additional data.

### BRIEF DESCRIPTION OF THE DRAWINGS

These and other features, aspects, and advantages of the present disclosure may become better understood when the following detailed description is read with reference to the accompanying drawings in which like characters represent like parts throughout the drawings, wherein:

FIG. 1 is a diagrammatic representation of an example batch manufacturing-related process, in accordance with an embodiment;

FIG. 2 is an illustration of an industrial automation system that includes a distributed control system (DCS), in accordance with an embodiment;

FIG. 3 is an illustration of an artificial intelligence (AI) modeling system for the industrial automation system, in accordance with an embodiment;

FIG. 4 is an illustration of example components that may be part of a control system for the AI modeling system, in accordance with an embodiment;

FIG. 5 is an illustration of a data model management architecture, in accordance with an embodiment;

FIG. 6 is a flow chart of a method for generating an AI model, in accordance with an embodiment;

FIG. 7 is a flow chart of a method for generating the AI model based on modified AI parameters, in accordance with an embodiment;

FIG. 8 is an illustration of a user interface for modifying one or more parameters of a Principal Component Analysis (PCA) Semi-Supervised Classification Model Training Portal, in accordance with an embodiment;

FIG. 9 is an illustration of a user interface for modifying one or more parameters of a Partial Least Squares (PLS) Regression Model Training Portal, in accordance with an embodiment;

FIG. 10 is an illustration of a user interface for modifying one or more parameters of an Automated AI (AutoAI) Regression Model Training Portal, in accordance with an embodiment;

FIG. 11 is an illustration of a user interface for modifying one or more parameters of an Automated AI (AutoAI) Classification Training Portal, in accordance with an embodiment;

FIG. 12 is an illustration of a user interface for a pre-procession code editor, in accordance with an embodiment;

FIG. 13 is an illustration of a predictor and target data selection user interface, in accordance with an embodiment;

FIG. 14 is an illustration of a range selection user interface, in accordance with an embodiment;

FIG. 15 is an illustration of a batch processing system that utilizes edge-deployed trained models for real-time monitoring, in accordance with an embodiment;

FIG. 16 is a flow chart of a method for determining one or more adjustments for operations of one or more industrial devices based on predicted operations, in accordance with an embodiment;

FIG. 17 is an illustration of a prediction visualization user interface for a Human Machine Interface (HMI), in accordance with an embodiment; and

FIG. 18 is an illustration of an operational control user interface for a Human Machine Interface (HMI), in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is generally directed towards industrial automation-related systems and methods that identify anomalies in batch processing via use of artificial intelligence models. Specifically, the systems and techniques discussed herein provide efficient mechanisms for generating trained artificial intelligence models useful for batch processing anomaly detection.

As mentioned above, traditional industrial batch processing systems may inefficiently detect anomalies in the operations of their respective systems, thereby resulting in delayed solutions to issues causing the anomalies. Indeed, the batch processing industry is facing increased pressure to make batch processing more efficient and consistent as the number of products (e.g., biological therapies) manufactured using batch processing continue to increase. With this in mind, the present embodiments described herein include systems and methods for collecting information technology (IT) and operational technology (OT) data from devices associated with the industrial batch processing system, such that an AI modeling system may analyze the collected data, identify baseline trends, and predict anomalous behavior of the industrial batch processing system in an efficient (e.g., time, computational processing, energy) manner. As such, operators of the industrial batch processing systems may diagnose any issues that may be present in real time based on predictive analytics at a physical level of the industrial batch processing system.

Further, the present embodiments described herein include a data model management architecture, an artificial intelligence (AI) training portal, a pre-processing system for minimizing software code engagement, and an automatic AI engine for training models based on real-time monitoring. The AI modeling system may employ the data model management architecture, which may detail streamlined structures to facilitate management (e.g., organization) of a collection of data related to the industrial batch processing system. Indeed, the data model management architecture may enable an arrangement and/or reuse of input and output data being received by and/or provided by the AI modeling system. The AI modeling system may receive data from various devices (e.g., industrial devices, information technology (IT) devices, operational technology (OT) devices, or any other suitable device) of the batch processing system. Further, the AI modeling system may model the data according to one or more modeling techniques (e.g., selected by a user). For example, the one or more modeling techniques may include machine learning (ML) training engines (e.g., portals). The AI modeling system may pre-process the data using pre-processing files associated with the modeling techniques.

Moreover, the AI modeling system may generate one or more training dataset files based on the pre-processed data and store the training dataset files for each respective modeling technique in a database. In this manner, the AI modeling system may employ the data model management architecture to more efficiently generate any number of AI models by retrieving the stored training dataset files. Moreover, the AI modeling system may generate an AI model based on the training dataset files and the data acquired from the various devices. In this manner, the AI modeling system may employ the data model management architecture to more efficiently retrieve the training dataset files and generate the AI models based on varying inputs provided by the user.

Therefore, to collect the appropriate datasets, the present embodiments include establishing a cohesive platform that eliminates the need for redundant data management, integration of information technology (IT) data sources and operational technology (OT) data sources, and consolidates AI training, real-time batch process condition monitoring, root cause identification, and/or visualization functionalities across tenancies without rebuilding of related workflows. Further, general researchers in a field and/or general users in industrial process-based manufacturing plants that use the same type of services may be provided access to the cohesive platform, enabling more accurate predictive processing with relatively less individual effort of these users.

The cohesive platform may also be a dynamic and adaptable platform that continuously incorporates updated options for users, thereby enabling process data analytics utilizing both conventional and innovative methods, while also accommodating emerging tools developed within the industry. As a result, the platform may bridge the divide between process engineers and data analytics by providing a code-free or minimal code platform that empowers process engineers to rapidly adopt and generate tailored models for detecting anomalies.

Although the following example environment in which the present embodiments may be implemented is described in terms of a petrochemical batch processing application, it should be understood that described embodiments may also improve operations in other applications. For example, as mentioned herein biopharmaceutical manufacturing processes may be greatly improved by the described techniques.

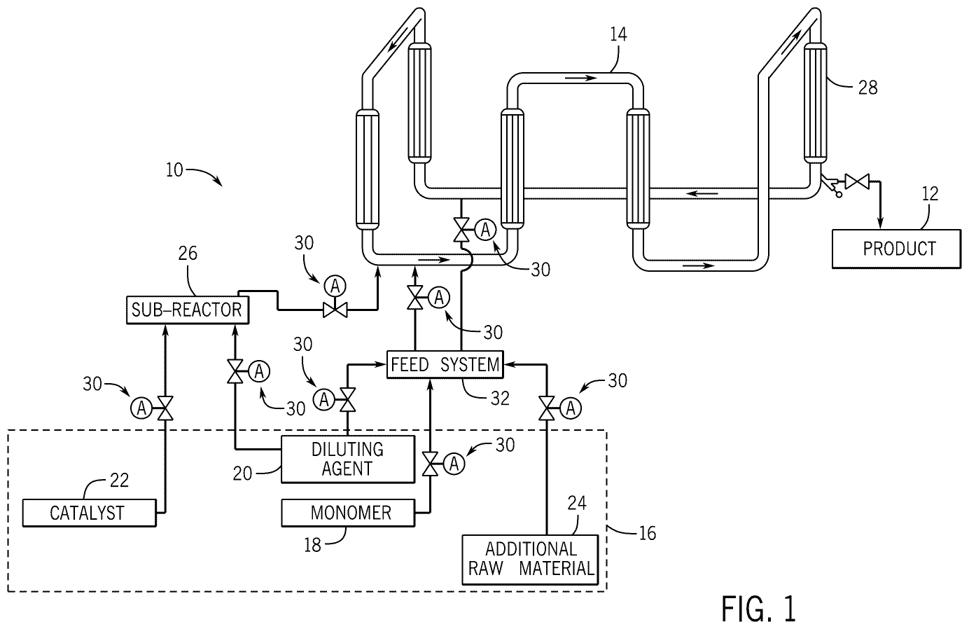

By way of introduction, FIG. 1 is a diagrammatic representation of a batch manufacturing-related process (e.g., petrochemical, bio-pharmaceutical, etc.) in which embodiments described below may be implemented. In particular, illustrated is an example reactor system 10, such as a polymerization reactor capable of processing olefin monomers, like ethylene or hexene, to produce homopolymers or co-polymers as products 12. Any suitable reactor may be used, including batch, slurry, gas-phase, solution, high pressure, tubular or autoclave reactors, or any combination thereof. For ease of discussion, FIG. 1 refers to a loop reactor 14 for polymerization. However, it should be noted that the discussion set forth below is intended to be applicable, as appropriate, to any bio-pharmaceutical process, petrochemical process, industrial process, manufacturing process, or the like, as a way to provide context to the following discussion.

Production processes, like the polymerization reactor process shown in FIG. 1, may occur on an ongoing basis as part of a continuous operation to generate products (e.g., product 12). Sometimes a variety of both continuous and batch systems may be employed throughout a production process. Various suppliers may provide reactor feedstocks 16 to the reactor system 10 via pipelines, trucks, cylinders, drums, and so forth. The suppliers may include off-site and/or on-site facilities, including olefin plants, refineries, catalyst plants, on or off-site laboratories, and the like. Examples of possible feedstocks 16 include olefin monomers 18, diluents or diluting agents 20, catalysts 22, and/or other additives. The other feed components, additional raw materials 24, may also be provided to the reactor 14. Feedstocks 16 may change when using different manufacturing processes and/or when manufacturing a different final product. The feedstocks 16 may be stored or processed in any suitable vessel or process, such as in monomer storage and feed tanks, diluent vessels, catalyst tanks, co-catalyst cylinders and tanks, treatment beds like molecular sieve beds and/or aluminum packing, and so forth, prior to or after being received at the reactor system 10. The reactor system 10 may include one type of reactor in a system or multiple reactors of the same or different type, and desired processing conditions in one of the reactors may be different from the operating conditions of the other reactors.

The product 12 may be moved from the reactor system 10 for additional processing, such as to form polymer pellets from the product 12. In general, the product 12, or processed product (e.g., pellets) may be transported to a product load-out area for storage, blending with other products or processed products, and/or loading into railcars, trucks, bags, ships, and so forth, for distribution to customers.

Processes, like the reactor system 10, may receive or process feedstocks 16 at relatively high pressures and/or relatively high temperatures. For example, a hydrogen feedstock may be handled by the reactor system 10 via pipeline at approximately 900-1000 pounds per square inch gauge (psig) at psig at 90-110° F. Furthermore, some products may be generated using highly reactive, unstable, corrosive, or otherwise toxic materials as the feedstock 16 or as intermediate products, such as hydrogen sulfide, pure oxygen, or the like. Heat, pressure, and other operating parameters may be employed appropriately to obtain appropriate reaction conditions, which may increase a reactivity, instability, or corrosive nature of the feedstock 16. These materials may be desired to be processed and transported using reliable and highly available systems, for example, to reduce a likelihood of a release event from occurring.

Each of the feedstocks 16, sub-reactor 26, and/or feed system 32 may use different operating parameters to create suitable output intermediate products for use in subsequent reactions or as a product output. Operating parameters of the reactor system 10 may include temperature, pressure, flow rate, mechanical agitation, product takeoff, component concentrations, polymer production rate, and so forth, and one or more may be selected on to achieve the desired polymer properties. Controlling temperature may include using a gas burner, an electrical heating conduit, a heat exchange device 28, or the like, to increase or reduce the temperature of intermediate products of the reactor system 10. As an example, during operation, a cooling fluid may be circulated within the cooling jackets of the heat exchange devices as needed to remove the generated heat and to maintain the temperature within the desired range, such as between approximately 1500 F to 250° F. (65° C. to 121° C.) for polyethylene.

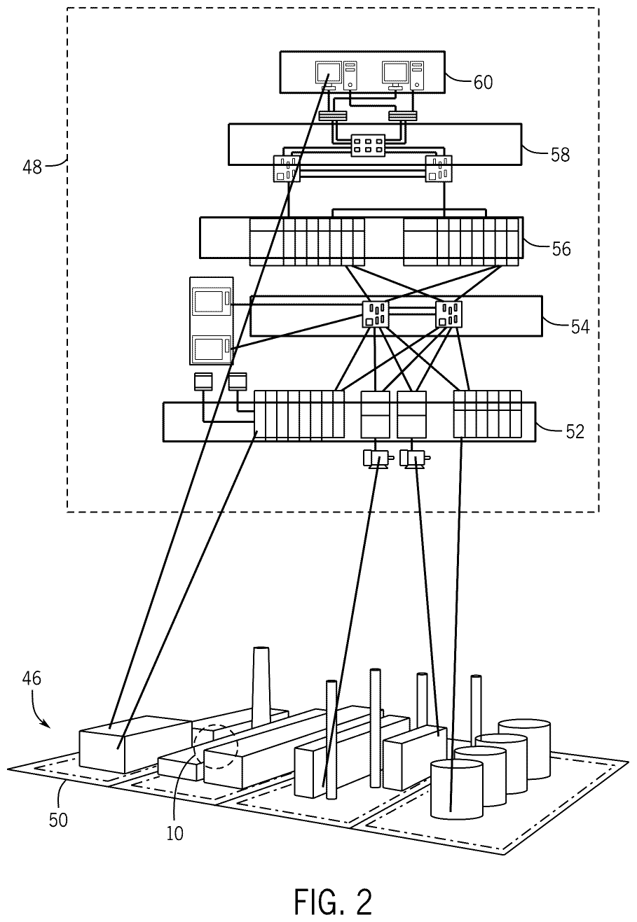

Feedstock 16 flow rates, control of operating parameters, and the like, may be managed by a control system (e.g., like the control system shown in FIG. 2). The control system may generate control signals, for example, control signals that are transmitted to one or more actuators 30 to cause the actuator to open or close (or partially open or partially close) as a way to control operating parameters of the feedstock 16, control of other operating parameters, and the like. Care may be taken when adjusting operating parameters since petrochemical manufacturing processing may be highly sensitive to erroneous operation. For example, fractions of a percentage of reliability change in a control system of the reactor system 10 may make a difference between a process being taken offline or a process working as expected.

With the foregoing in mind, the components of the reactor system 10 may be connected to an AI modeling system described herein, to enable efficient use of AI functionalities. Indeed, with the techniques described herein, information technology (IT) data (e.g., data associated with business processes and/or organization management) and operational technology (OT) data (e.g., data associated with control and/or operation of physical devices and processes) integration may be performed with little to no redundant development across tenancies. Further, the AI modeling system may provide adaptable tools for efficient process data analytics via code-free and/or minimal code tools, bridging the gap between process engineers and data analytics. In this manner, edge-detection of batch process anomalies may be efficiently implemented, resulting in more effective batch processing within the industrial environment.

Referring now to FIG. 2, FIG. 2 is an illustration of an example industrial automation system 46 that includes a distributed control system 48 (e.g., a “DCS”). The industrial automation system 46 may include the reactor system 10 from FIG. 1 and/or any number of industrial automation components.

Industrial automation components may include a user interface, the distributed control system 48, a motor drive, a motor, a conveyor, specialized original equipment manufacturer machines, fire suppressant system, and any other device that may enable production or manufacture products or process certain materials. In addition to the aforementioned types of industrial automation components, the industrial automation components may also include controllers, input/output (IO) modules, motor control centers, motors, human-machine interfaces (HMIs), user interfaces, contactors, starters, sensors, drives, relays, protection devices, switchgear, compressors, network switches (e.g., Ethernet switches, modular-managed, fixed-managed, service-router, industrial, unmanaged), and the like. The industrial automation components may also be related to various industrial equipment such as mixers, machine conveyors, tanks, skids, specialized original equipment manufacturer machines, and the like. The industrial automation components may also be associated with devices used in conjunction with the equipment such as scanners, gauges, valves, and the like. In one embodiment, every aspect of the industrial automation component may be controlled or operated by a single controller (e.g., control system). In another embodiment, the control and operation of each aspect of the industrial automation components may be distributed via multiple controllers (e.g., control system).

The industrial automation system 46 may divide logically and physically into different units 50 corresponding to cells, areas, factories, subsystems, or the like of the industrial automation system 46. The industrial automation components (e.g., load components, processing components) may be used within a unit 50 to perform various operations for the unit 50. The industrial automation components may be logically and/or physically divided into the units 50 as well to control performance of the various operations for the unit 50.

The distributed control system 48 may include computing devices with communication abilities, processing abilities, and the like. For example, the distributed control system 48 may include processing modules, a control system, a programmable logic controller (PLC), a programmable automation controller (PAC), or any other controller that may monitor, control, and operate an industrial automation device or component. The distributed control system 48 may be incorporated into any physical device (e.g., the industrial automation components) or may be implemented as a stand-alone computing device (e.g., general purpose computer), such as a desktop computer, a laptop computer, a tablet computer, a mobile device computing device, or the like. For example, the distributed control system 48 may include many processing devices logically arranged in a hierarchy to implement control operations by disseminating control signals, monitoring operations of the industrial automation system 46, logging data as part of historical tracking operations, and so on.

In an example distributed control system 48, different hierarchical levels of devices may correspond to different operations. A first level 52 may include input/output communication modules (IO modules) to interface with industrial automation components in the unit 50. A second level 54 may include control systems that control components of the first level and/or enable intercommunication between components of the first level 52, even if not communicatively coupled in the first level 52. A third level 56 may include network components, such as network switches, that support availability of a mode of electronic communication between industrial automation components. A fourth level 58 may include server components, such as application servers, data servers, human-machine interface servers, or the like. The server components may store data as part of these servers that enable industrial automation operations to be monitored and adjusted over time. A fifth level 60 may include computing devices, such as virtual computing devices operated from a server to enable human-machine interaction via an HMI presented via a computing device. It should be understood that levels of the hierarchy are not exhaustive and nonexclusive, and thus devices described in any of the levels may be included in any of the other levels. For example, any of the levels may include some variation of an HMI.

One or more of the levels or components of the distributed control system 48 may use and/or include one or more processing components, including microprocessors (e.g., field programmable gate arrays, digital signal processors, application specific instruction set processors, programmable logic devices, programmable logic controllers), tangible, non-transitory, machine-readable media (e.g., memory such as non-volatile memory, random access memory (RAM), read-only memory (ROM), and so forth. The machine-readable media may collectively store one or more sets of instructions (e.g., algorithms) in computer-readable code form, and may be grouped into applications depending on the type of control performed by the distributed control system 48. In this way, the distributed control system 48 may be application-specific, or general purpose.

Furthermore, portions of the distributed control system 48 may be a or a part of a closed loop control system (e.g., does not use feedback for control), an open loop control system (e.g., uses feedback for control), or may include a combination of both open and closed system components and/or algorithms. Further, in some embodiments, the distributed control system 48 may utilize feed forward inputs. For example, depending on information relating to the feedstocks 16 (e.g., compositional information relating to the catalyst 22 and/or the additional raw material 24, the distributed control system 48 may control the flow of any one or a combination of the feedstocks 16 into the sub-reactor 26, the reactor 14, or the like. Each of the levels 52, 54, 56, 58, 60 may include component redundancies, which may help provide a high availability control system. For example, within the first level, redundant and concurrently operating backplanes may provide power to each of the IO modules.

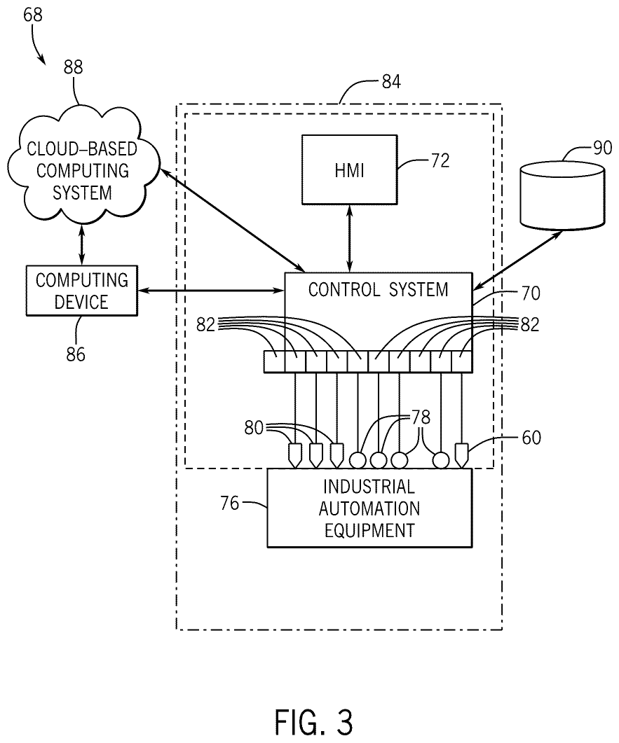

In any case, data collected from the distributed control system 48, stored in a central repository, or the like may be made available to an AI modeling system 68. FIG. 3 illustrates the AI modeling system 68 that may be employed in any suitable industrial automation system 46. In FIG. 3, the AI modeling system 68 is illustrated as including a control system 70 adapted to interface with devices that may monitor and control various types of industrial automation equipment 76 (e.g., industrial automation components, industrial devices), such as the reactor 14, the sub-reactor 26, the actuators 30, the feed system 32, or any other industrial automation components described in FIGS. 1 and 2. For example, the industrial automation components may include the IO modules of the first level 52, the control systems of the second level 54, the network components of the third level 56, the server components of the fourth level 58, and/or the computing devices of the fifth level 60. The AI modeling system 68 may also include a human machine interface (HMI) 72.

Further, it should be noted that the industrial automation equipment 76 may take many forms and include devices for accomplishing many different and varied purposes. For example, the industrial automation equipment 76 may include machinery used to perform various operations in a compressor station, an oil refinery, a batch operation for making food items, a mechanized assembly line, and so forth. Accordingly, the industrial automation equipment 76 may comprise a variety of operational components, such as electric motors, valves, actuators, temperature elements, pressure sensors, or a myriad of machinery or devices used for manufacturing, processing, material handling, and other applications.

Additionally, the industrial automation equipment 76 may include various type equipment that may be used to perform the various operations that may be part of an industrial application. For instance, the industrial automation equipment 76 may include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation equipment 76 may be made up of certain automation devices, which may include controllers, input/output (I/O) modules, motor control centers, motors, HMIs, operator interfaces, contactors, starters, sensors, actuators, drives, relays, protection devices, switchgear, compressors, firewall, network switches (e.g., Ethernet switches, modular-managed, fixed-managed, service-router, industrial, unmanaged, etc.) and the like.

In certain embodiments, one or more properties of the industrial automation equipment 76 may be monitored and controlled by certain equipment for regulating control variables used to operate the industrial automation equipment 76. For example, sensors 78 and actuators 80 may monitor various properties of the industrial automation equipment 76 and may adjust operations of the industrial automation equipment 76, respectively.

In some cases, some cases, the industrial automation equipment 76 may be associated with devices used by other equipment. For instance, scanners, gauges, valves, flow meters, and the like may be disposed on industrial automation equipment 76. Here, the industrial automation equipment 76 may receive data from the associated devices and use the data to perform their respective operations more efficiently. For example, a controller (e.g., control system 70) of a motor drive may receive data regarding a temperature of a connected motor and may adjust operations of the motor drive based on the data.

In certain embodiments, the industrial automation equipment 76 may include a communication component that enables the industrial automation equipment 76 to communicate data between each other and other devices. The communication component may include a network interface that may enable the industrial automation equipment 76 to communicate via various protocols such as Ethernet/IP®, ControlNet®, DeviceNet®, or any other industrial communication network protocol. Alternatively, the communication component may enable the industrial automation equipment 76 to communicate via various wired or wireless communication protocols, such as Wi-Fi, mobile telecommunications technology (e.g., 2G, 3G, 4G, LTE), Bluetooth®, near-field communications technology, and the like

It should be noted that the HMI 72 and the control system 70, in accordance with embodiments of the present techniques, may be facilitated by the use of certain network strategies. Indeed, an industry standard network may be employed, such as DeviceNet, to enable data transfer. Such networks permit the exchange of data in accordance with a predefined protocol, and may provide power for operation of networked elements.

The sensors 78 may be any number of devices adapted to provide information regarding process conditions. The actuators 80 may include any number of devices adapted to perform a mechanical action in response to a signal from a controller (e.g., the control system 70). The sensors 78 and actuators 80 may be utilized to operate the industrial automation equipment 76. Indeed, they may be utilized within process loops that are monitored and controlled by the control system 70 and/or the HMI 72. Such a process loop may be activated based on process inputs (e.g., input from a sensor 78) or direct operator input received through the HMI 72. As illustrated, the sensors 78 and actuators 80 are in communication with the control system 70. Further, the sensors 78 and actuators 80 may be assigned a particular address in the control system 70 and receive power from the control system 70 or attached modules.

Input/output (I/O) modules 82 may be added or removed from the control system 70 via expansion slots, bays or other suitable mechanisms. In certain embodiments, the I/O modules 82 may be included to add functionality to the control system 70, or to accommodate additional process features. For instance, the I/O modules 62 may communicate with new sensors 78 or actuators 80 added to monitor and control the industrial automation equipment 76. It should be noted that the I/O modules 82 may communicate directly to sensors 78 or actuators 80 through hardwired connections or may communicate through wired or wireless sensor networks, such as Hart or IOLink.

Generally, the I/O modules 82 serve as an electrical interface to the control system 70 and may be located proximate or remote from the control system 70, including remote network interfaces to associated systems. In such embodiments, data may be communicated with remote modules over a common communication link, or network, wherein modules on the network communicate via a standard communications protocol. Many industrial controllers can communicate via network technologies such as Ethernet (e.g., IEEE802.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems.

In the illustrated embodiment, several of the I/O modules 82 may transfer input and output signals between the control system 70 and the industrial automation equipment 76. As illustrated, the sensors 78 and actuators 80 may communicate with the control system 70 via one or more of the I/O modules 82. In certain embodiments, the control system 70 (e.g., the HMI 72, the control system 70, the sensors 78, the actuators 80, the I/O modules 82) and the industrial automation equipment 76 may make up an industrial automation application 84. The industrial automation application 84 may involve any type of industrial process or system used to manufacture, produce, process, or package various types of items. For example, the industrial applications 84 may include industries such as material handling, packaging industries, manufacturing, processing, batch processing, the example industrial automation system 46 of FIG. 2, and the like

In certain embodiments, the control system 70 may be communicatively coupled (e.g., wired or wirelessly) to a computing device 86, a cloud-based computing system 88, and/or a central repository 90. In this network, input and output signals generated from the control system 70 may be communicated between the computing device 86 and the cloud-based computing system 88. Although the control system 70 may be capable of communicating with the computing device 86 and the cloud-based computing system 88, as mentioned above, in certain embodiments, the control system 70 may perform certain operations and analysis without sending data to the computing device 66 or the cloud-based computing system 88.

In some embodiments, the cloud-based computing system 88 may host a number of services via computing system resources that may be distributed over multiple locations. In this way, the various computing system resources may be scaled as needed to perform various operations. In some embodiments, the AI modeling system 68 may be implemented via the cloud-based computing system 88, as a separate computing system, or both.

Further, datasets acquired via the industrial automation equipment 76, the distributed control system 48, the AI modeling system 68, or the like may be stored in the central repository 90. In addition, simulated datasets acquired by digital twin systems that mirror or simulate the operations of an industrial automation system may be included in the central repository 90. In any case, the central repository 90 may include one or more databases or data structures for storing and querying datasets in a structured and efficient manner. In addition, the results of the AI training, real-time batch process condition monitoring, root cause identification, visualization functionalities, and/or any other suitable process performed by the AI modeling system 68 described herein may be stored in the central repository 90, such that previously performed analysis operations may be reviewed, modified, and redeployed for different datasets. Accordingly, storage of organized data (e.g., organized by the AI modeling system 68) in the central repository 90 may improve efficiency of AI model generation for various projects and/or users by facilitating more efficient data retrieval.

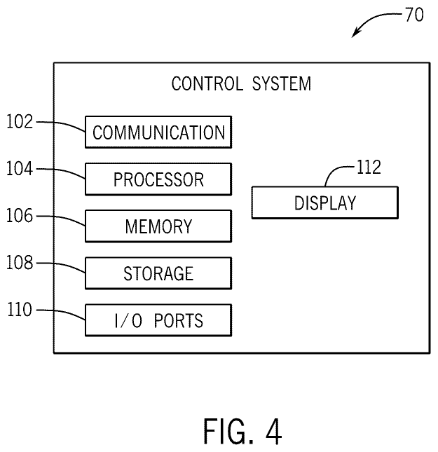

FIG. 4 illustrates example components that may be part of the control system 70, in accordance with an embodiment. For example, the control system 70 may include a communication component 102, a processor 104, a memory 106, a storage 108, input/output (I/O) ports 110, a display 112, and the like. The communication component 102 may be a wireless or wired communication component that may facilitate communication between the industrial automation equipment 76, the cloud-based computing system 88, the central repository 90, and other communication capable devices.

The processor 104 may be any type of computer processor or microprocessor capable of executing computer-executable code. The processor 104 may also include multiple processors, processing circuitry, or a processing system that may perform the operations described below. The memory 106 and the storage 108 may be any suitable articles of manufacture that can serve as media to store processor-executable code, data, or the like. These articles of manufacture may represent computer-readable media (e.g., any suitable form of memory or storage) that may store the processor-executable code used by the processor 104 to perform the presently disclosed techniques. Generally, the processor 104 may execute software applications that include programs that enable a user to generate AI models based on accessible datasets to better ascertain issues or solutions to various discrepancies, anomalies, or the like. That is, the software applications may communicate with the AI modeling system 68 and gather information associated with operations of the industrial automation equipment 76 (e.g., via the sensors 78 disposed on the industrial automation equipment 76) and provide a user interface (e.g., a graphical user interface) via a visualization to enable a user to select one or more modeling techniques, modify (e.g., adjust) parameters of the AI model, interact with artificial intelligence (AI) systems, and the like.

The memory 106 and the storage 108 may also be used to store the data, analysis of the data, the software applications, and the like. The memory 106 and the storage 108 may represent non-transitory computer-readable media (e.g., any suitable form of memory or storage) that may store the processor-executable code used by the processor 104 to perform various techniques described herein. It should be noted that non-transitory merely indicates that the media is tangible and not a signal.

In one embodiment, the memory 106 and/or storage 108 may include a software application that may be executed by the processor 104 and may be used to monitor, control, access, or view one of the industrial automation components. As such, the AI modeling system 68 may communicatively couple to industrial automation components or to a respective computing device of the industrial automation equipment 76 via a direct connection between the devices, via the cloud-based computing system 88, or the like.

The I/O ports 110 may be interfaces that may couple to other peripheral components such as input devices (e.g., keyboard, mouse), sensors, input/output (I/O) modules, and the like. I/O modules may enable the AI modeling system 68 to communicate with the industrial automation equipment 76 or other devices in the industrial automation system 46 via the I/O modules.

The display 112 may depict visualizations associated with software or executable code being processed by the processor 104. In one embodiment, the display 112 may be a touch display capable of receiving inputs from a user of the control system 70. As such, the display 112 may serve as a user interface to provide parameters and instructions to guide the operation of the AI modeling system 68. The display 112 may be used to display a graphical user interface (GUI) for operating the AI modeling system 68. The display 112 may be any suitable type of display, such as a liquid crystal display (LCD), plasma display, or an organic light emitting diode (OLED) display, for example. Additionally, in one embodiment, the display 112 may be provided in conjunction with a touch-sensitive mechanism (e.g., a touch screen) that may function as part of a control interface for the industrial automation equipment 76 to control the general operations of the industrial automation system 46 or the like.

Although the components described above have been discussed with regard to the control system 70, it should be noted that similar components may make up other computing devices described herein. Further, it should be noted that the listed components are provided as example components and the embodiments described herein are not to be limited to the components described with reference to FIG. 4.

With the foregoing in mind, in some embodiments, the AI modeling system 68 may enable users to efficiently use AI functionalities with little to no redundant data management by consolidating AI training, real-time batch process condition monitoring, root cause identification, and/or visualization functionalities. Further, the systems and methods described herein are accessible and/or applicable to various users of industrial process-based manufacturing plants (e.g., of the reactor system 10, the industrial automation system 46). As described herein, the AI modeling system 68 may also provide adaptable tools for efficient process data analytics via code-free and/or minimal code tools, bridging the gap between process engineers and data analytics. As such, edge-detection of batch process anomalies may be efficiently implemented, resulting in more effective batch processing within the industrial environment. Indeed, the AI modeling system 68 may identify irregularities and/or deviations in batch processing at a network edge (e.g., a source where data is generated) efficiently by leveraging computing capabilities of any suitable device or component of the industrial automation system 46 at or near the data source.

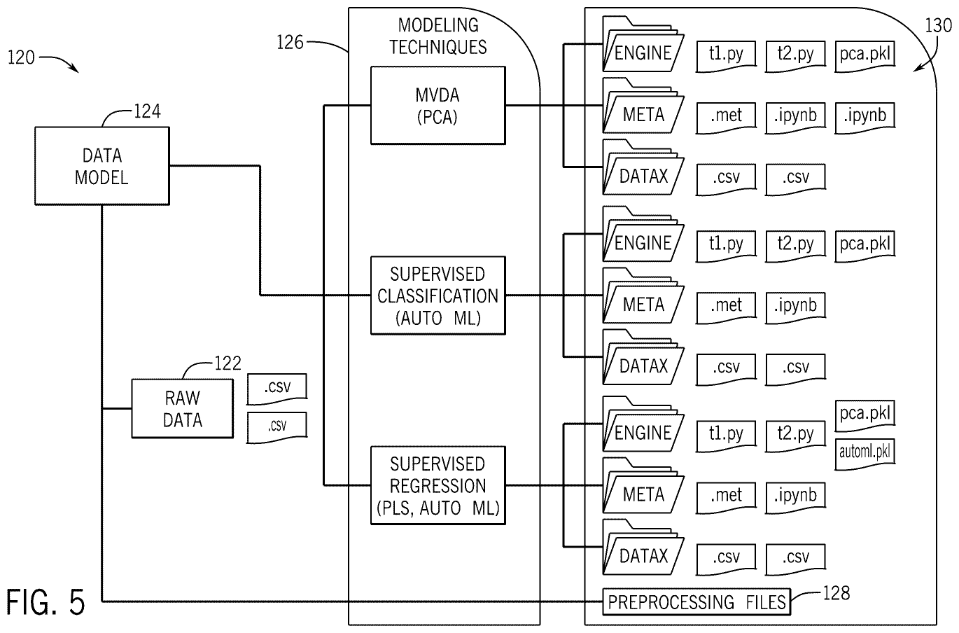

With the foregoing in mind, FIG. 5 is an illustration of a data model management architecture 120. The data model management architecture 120 details an organizational framework (e.g., streamlined structure) to facilitate management of collection of data (e.g., raw data) from various IT and OT devices related to the industrial automation system 46. Indeed, the data model management architecture 120 may enable processing of input and output files registered and/or retrieved by the AI modeling system 68. Further, the data model management architecture 120 may enable pre-processing of the input and output files to create respective AI models that employ a respective classification algorithm and related independent and dependent variables. As such, the AI modeling system 68 may incorporate the data model management architecture 120 to reduce data duplication operations and efficiently use the data for model generation. That is, the data model management architecture 120 may provide the AI modeling system 68 a structured approach (e.g., comprehensive workflow) to organizing, storing, and/or processing data in a manner that supports efficient data operations and model generation. Therefore, the AI modeling system 68 may incorporate the data model management architecture 120 to receive, process, and/or utilize the data more efficiently when generating AI models. It should be noted that although the operations described herein will be described as being performed by the AI modeling system 68 (e.g., the control system 70 of the AI modeling system 68), any suitable computing device (e.g., the computing device 86), cloud-based computing system (e.g., the cloud-based computing system 88), or separate computing system or computing device may enable the user to perform the operations described herein.

By incorporating the data model management architecture 120, the control system 70 may receive data 122 (e.g., raw data) from various industrial devices. For example, the data 122 may be received from various IT and/or OT devices associated with the reactor system 10 and/or the industrial automation system 46, the central repository 90, and/or the like. As another example, the data may be received from any suitable device of the industrial automation equipment 76. The control system 70 may incorporate the data received from the various industrial devices to create a data model 124 based on the data model management architecture 120. The data model 124 may be generated based on one or more modeling techniques 126, which may enable modeling and/or analysis of the data 122 according to the one or more modeling techniques 126. The modeling techniques 126 may enable preparation of the raw data 122 for further processing and/or modeling. Indeed, the modeling techniques 126 may enable generation of the data model 124, which includes various representations of data structures, relationships, and/or constraints within a respective system. The modeling techniques 126 may include using respective pre-processing files 128 (e.g., stored in the central repository 90) that may enable creation of an AI model (e.g., constant AI model), which may employ a respective classification algorithm and/or associated independent and dependent variables. For each of the modeling techniques 126, different pre-processing files 128 may be used to generate the respective AI model. That is, the pre-processing files 128 associated with a respective modeling technique 126 may be used to pre-process the data 122 and generate one or more training data set files for the respective modeling technique 126.

The one or more modeling techniques 126 may include one or more machine learning (ML) training portals at a project level. For example, the one or more modeling techniques 126 may include a Multi-Variable Data Analysis portal, a Supervised Classification portal, a Supervised Regression portal, or any other suitable ML training portal. It should be noted that although three modeling techniques 126 are illustrated in FIG. 5, the data model management architecture 120 may include any suitable number of modeling techniques 126. In some embodiments, the user may select at least one of the one or more modeling techniques 126 to cause the control system 70 to pre-process the data 122. The control system 70 may pre-process the data 122 using the pre-processing files 128 associated with the selected modeling technique 126. For example, the pre-processing files 128 may contain code or algorithms designed to execute and/or automate tasks on the raw data 122, such as data cleaning (e.g., handling missing values, error correction, and the like), data transformation (e.g., normalization, encoding, and the like), data reduction (e.g., filtration, aggregation, and the like), data integration (e.g., data merging from multiple sources), and/or data preparation of datasets. The control system 70 may access or retrieve the pre-processing files 128 associated with the selected modeling technique 126 from the central repository 90 and perform pre-processing on the data 122. In some embodiments, the pre-processing files 128 may enable the AI modeling system 68 to filter data from the central repository 90 that is not relevant to a training objective associated with the modeling technique 126. Further, filtering the data from the central repository 90 may enable the AI modeling system 68 to efficiently retrieve data that may be relevant for training the AI model.

Thus, the control system 70 may generate one or more training dataset files 130 based on the pre-processed data. The one or more training dataset files 130 may enable generation of respective AI models. That is, the training dataset files 130 may be used to train the respective AI models to learn patterns, features, and/or relationships within the datasets and make predictions based on the datasets. For example, the training dataset files 130 may include a python (PY) file may include the pre-processing results of the data 122 for the selected modeling technique 126. Additionally, the training dataset files 130 may include a pickle (PKL) file may store a trained model for a respective modeling technique 126. The training dataset files 130 may also include a Jupyter Notebook (IPYNB) file, which may include processing code and/or model training codes that may be used by the respective modeling technique 126. Moreover, the training dataset files 130 may include a comma-separated values (CSV) file may include respective input data, the pre-processed data, and/or other output data that may have been generated via the respective modeling technique 126. In addition, the training dataset files 130 may include a metadata (MET) file may include any metadata information related to respective modeling techniques 126. It should be noted that the examples of training dataset files 130 provided above are not exhaustive and any suitable type of training dataset file may be generated and/or used by the control system 70.

As such, the data model management architecture 120 may enable the AI modeling system 68 to transform the data 122 and/or create the AI models based on the data 122. That is, transformation on the data 122 may be executed by the AI modeling system 68 to create (e.g., generate) the training dataset files 130 used in model preparation. The AI modeling system 68 may then store the training dataset files 130 in the central repository 90. In some embodiments, the cloud-based computing system 88 may host any number of modeling strategies, data transformations, and AI models for various batch processing systems and/or industrial automation systems. In this manner, the AI modeling system 68 may organize data associated with the modeling strategies, the data transformation, and/or the AI models in a structured way, such that the data may be efficiently retrieved via the cloud-based computing system 88 for future model generation. In some embodiments, the modeling strategies may be delivered via software-as-a-service tools, containers, or other suitable technologies. Indeed, different users (e.g., tenants) may use the same data 122 to perform different modeling techniques 126 to determine effectiveness of a resultant AI model for anomaly detection, operational projections, and the like.

In some embodiments, the training dataset files 130 may be generated, stored, and/or retrieved on a per-project basis and/or on a user-basis. For example, the AI modeling system 68 may store the training dataset files 130 based on a type of equipment, a type of industry, a geographical region, and the like. Further, various devices and data sources may be used to engaged a user-level importation of the data 122 to allow for its reuse across various projects. For example, as described herein, the AI modeling system 68 may store the training dataset files 130 and an association between the training dataset files 130, the industrial devices (e.g., the type of equipment), or both in the central repository 90. Further, the AI modeling system 68 may receive a request to generate an additional model representative of one or more additional expected operations of additional industrial devices of an additional industrial system (e.g., different from the industrial automation system 46), which may include similarities to the industrial devices of the industrial automation system 46. Moreover, the AI modeling system 68 may then receive additional data associated with the additional industrial devices and efficiently retrieve the training dataset files 130 based on the additional data. The AI modeling system 68 may then generate the additional model based on the training dataset files 130 and the additional data, thereby improving efficiency and reducing latency by reducing pre-processing operations involved in generating the additional model. In some embodiments, the user may also modify the AI model previously generated and stored by the AI modeling system 68 by adjusting parameters associated with the AI model.

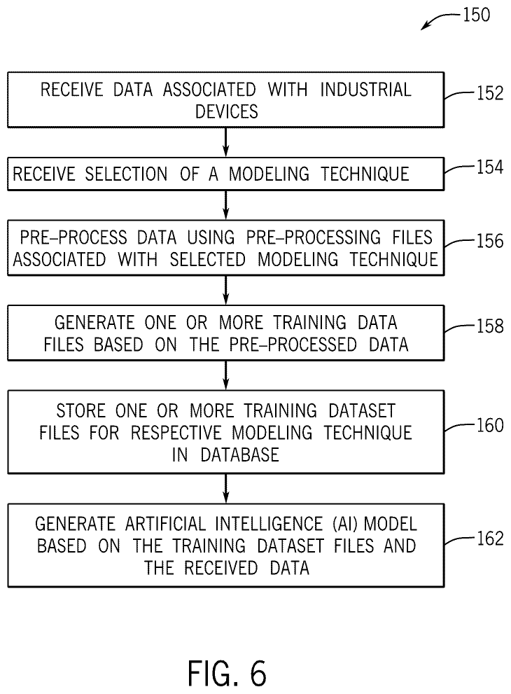

With the foregoing in mind, FIG. 6 is a flow chart of a method 150 for generating the AI model, in accordance with an embodiment. Although the following description of FIG. 6 is discussed as being performed by the AI modeling system 68, it should be understood that any suitable computing device may perform the method 150 in any suitable order.

Referring now to FIG. 6, at process block 152, the AI modeling system 68 may receive data (e.g., the raw data 122) associated with industrial devices. Indeed, as described herein, the data may be received from any suitable device of the industrial automation system 46. For example, the data may include operational data (e.g., real-time data on the performance and operation of the industrial devices), environmental data (e.g., data related to environment around the industrial devices, such as the environment of the industrial automation system 46), energy consumption data (e.g., amount of energy consumed), diagnostic data (e.g., health and status of the industrial devices), historical data (e.g., data associated with historical operations), and the like.

At process block 154, the AI modeling system 68 may receive a selection of a modeling technique 126 (e.g., of the one or more modeling techniques 126), which may enable preparation of the data associated with the industrial devices for further processing and/or modeling. For example, the AI modeling system 68 may receive the selection of the modeling technique 126 via a user input by the user. That is, the one or more modeling techniques 126 may be presented to the user via the user interface and the user may select the modeling technique 126 to utilize particular parameters and/or actions associated with the modeling technique 126 for preparing the data for AI modeling.

The selected modeling technique 126 may be associated with a set of pre-processing files 128 that may be used to pre-process the data. Therefore, at process block 156, the AI modeling system 68 may pre-process the data using the pre-processing files 128 associated with the selected modeling technique 126. As described herein, for example, the pre-processing files 128 may contain code or algorithms designed to execute (e.g., perform) and/or automate tasks on the data, such as data cleaning, transformation, reduction, integration, and/or preparation. At process block 158, the AI modeling system 68 may generate the one or more training dataset files 130 based on the pre-processed data. The one or more training dataset files 130 may enable the AI modeling system 68 to train respective AI models to learn patterns, features, and/or relationships within the datasets and make predictions based on the training dataset files 130.

At process block 160, the AI modeling system 68 may store one the one or more training dataset files 130 for the respective modeling technique (e.g., the selected modeling technique 126) in the central repository 90 (e.g., a database). Indeed, the AI modeling system 68 may store an association between the one or more training dataset files and the selected modeling technique 126. In some embodiments, the AI modeling system 68 may also store an association between the one or more training dataset files 130, the selected modeling technique 126, and a type of device or equipment (e.g., the industrial device) associated with the data. For example, the one or more training dataset files 130 may be stored with respect to a type of equipment the data is associated with, a type of industry the data is associated with, a geographical region of the industrial automation system 46, a time period during which the data was collected, and on the like.

At process block 162, the AI modeling system 68 may generate the selected AI model based on the training dataset files 130 and the received data. The selected AI model may be associated with the selected modeling technique 126. The AI model may be trained based on the training dataset files 130 and the received data during which the AI model may learn to map inputs to desired outputs by adjusting parameters associated with the AI model. The AI modeling system 68 may then use the AI model to model or simulate operations, anomalies, and functions performed in any suitable environment or device, such as the industrial automation system 46, a device within the industrial automation system 46, a digital twin, and so on, to track anomalies of the systems and/or devices. For example, the AI modeling system 68 may execute (e.g., perform) a simulation and employ the AI model to detect a number of anomalies that may be present in batch processing.

Further, the AI modeling system 68 may adjust operations of one or more industrial devices based on the AI model. For example, the AI model may be employed to analyze the received data, detect and/or predict anomalies, and adjust the operations of the industrial devices based on the detected or predicted anomalies to correct the anomalies. For example, the adjustments may include adjusting one or more settings of the industrial devices, activating a backup device, notifying the user of the anomalies, and the like. Further, different users (or tenants) may employ the same or similar received data for different modeling techniques 126 to determine effectiveness of the resultant AI model for anomaly detection, operational projections, and the like. In this manner, the data may be efficiently reused for the generation of respective AI models across multiple projects.

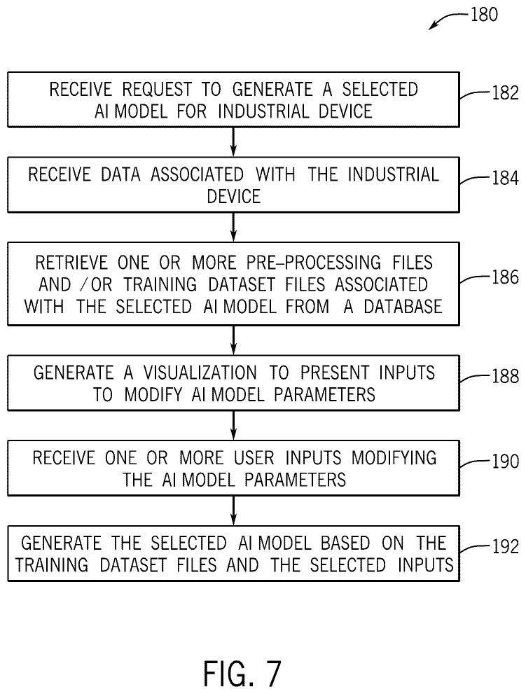

In some embodiments, a user may modify parameters (e.g., via user inputs) used by the AI modeling system 68 to train the AI model and generate the AI model based on the modified parameters. With the foregoing in mind, FIG. 7 is a flow chart of a method 180 for generating the AI model based on modified AI parameters, in accordance with an embodiment. Although the following description of FIG. 7 is discussed as being performed by the AI modeling system 68, it should be understood that any suitable computing device may perform method 180 in any suitable order.

At process block 182, the AI modeling system 68 may receive a request to generate a selected AI model for an industrial device. For example, the AI modeling system 68 may receive the request via a user input. At process block 184, the AI modeling system 68 may receive data associated with the industrial device, such as the operational data, the environmental data, the energy consumption data, the diagnostic data, the historical data, and the like. Moreover, at process block 186, the AI modeling system 68 may retrieve one or more pre-processing files 128 and/or training dataset files 130 associated with the selected AI model from a database (e.g., from the central repository 90). As described herein, the AI modeling system 68 may generate the selected AI model based on a respective modeling technique 126 and associated pre-processing files 128 stored in the database. Further, the AI modeling system 68 may generate the training dataset files 130 based on data that has been received and pre-processed by the AI modeling system 68 based on a selected modeling technique 126. The pre-processing files 128 and/or the training dataset files 130 may be stored in the database on a project and/or user basis. Thus, the AI modeling system 68 may retrieve the pre-processing files 128 and/or the training dataset files 130 that are generated and/or stored in the database based on its relationship to the project, user, or both. It should be noted that the AI modeling system 68 may implement the data model management architecture 120 of FIG. 5 to efficiently retrieve the pre-processing files 128 and/or the training dataset files 130.

At process block 188, the AI modeling system 68 may generate a visualization to present inputs to modify AI model parameters (e.g., variables). In particular, the AI model parameters may be associated with training parameters for the respective AI model. For example, the visualization may include a user interface with drop down menus for each respective parameter to adjust the AI model parameters for the AI model the user intends to use. Indeed, the AI modeling system 68 may access the AI model parameters made available via the data model management architecture 120 of FIG. 5 to display the parameters via the user interface and enable efficient modification of the AI model parameters.

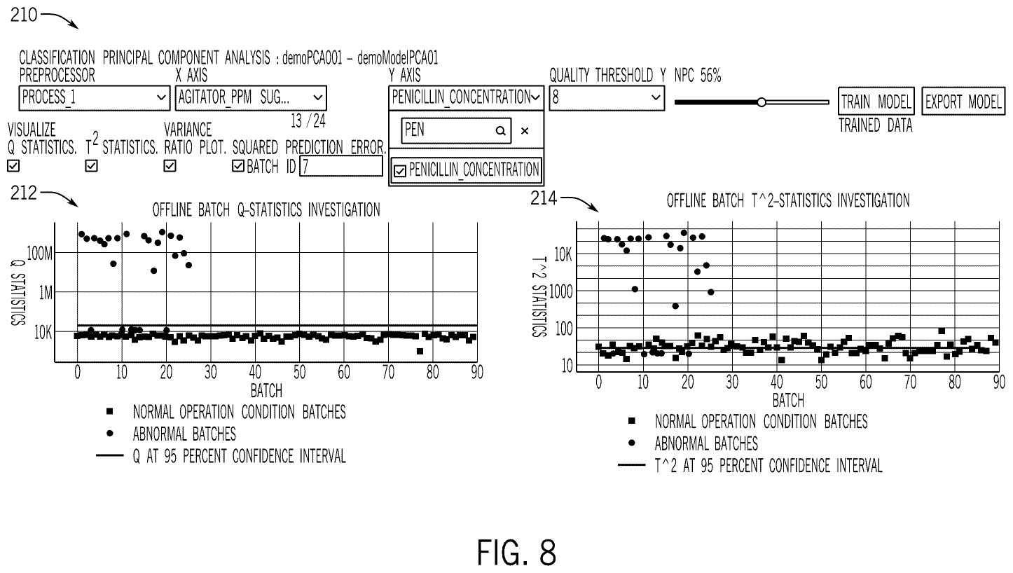

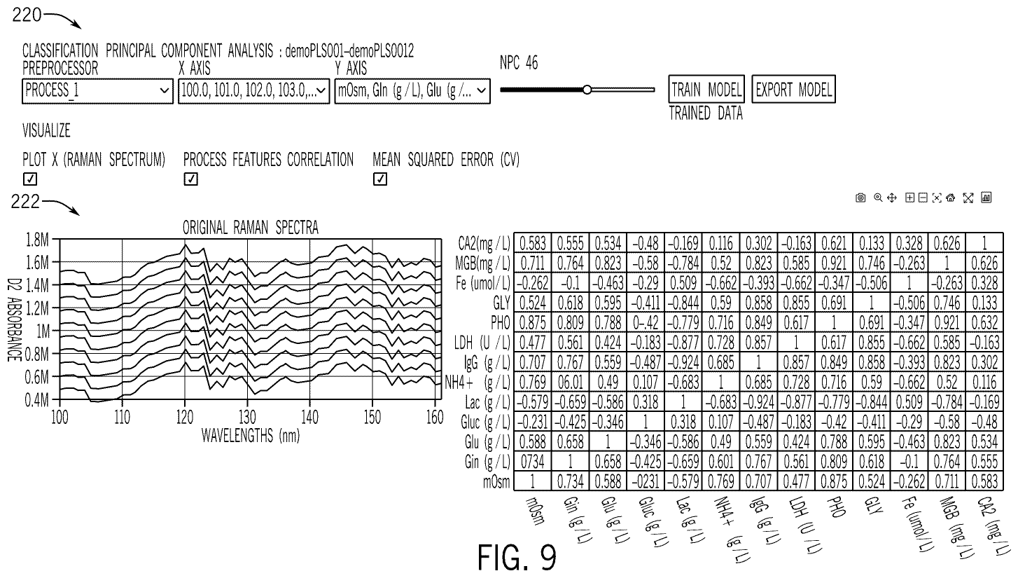

The AI modeling system 68 may present (e.g., provide) the visualization to the user to enable the user to efficiently input modifications to the AI model parameters. As such, at process block 190, the AI modeling system 68 may receive user inputs for modifying the AI model parameters. As an example, the inputs may include model independent variables selected from a set of process variables (e.g., from the data model management architecture 120). For instance, FIG. 8 is an illustration of a user interface 210 for modifying one or more parameters of a PCA Semi-Supervised Classification Model Training Portal. Further, FIG. 9 is an illustration of a user interface 220 for modifying one or more parameters of a PLS Regression Model Training Portal. The user may select inputs via the user interface of FIG. 8, the user interface of FIG. 9, or any other suitable user interface associated with a type of training portal to modify any number of ML modeling parameters.

As an example, as illustrated in FIG. 8, the user may select inputs, such as a pre-processor file, one or more independent variables (e.g., x-axis), and/or one or more dependent variables (e.g., y-axis), via the user interface 210. As illustrated in FIG. 8, other inputs may include a quality threshold, a Non-Process Chemical (NPC) percentage, and the like. The user may select the pre-processor file that may be employed in generating output data for the associated training portal (e.g., the PCA Semi-Supervised Classification Model Training Portal). The user may also select the independent variables (e.g., model independent variables) and/or dependent variables from the set of process variables. Moreover, the threshold may be set for a continuous value of the dependent variable or to a discrete value and perform the respective classification. Additionally or alternatively, the user may select a number of components to project (e.g., apply) to the data to and/or to perform training. As will be described in further detail below, the user interface 210 may also include inputs (e.g., selectable inputs, such as selectable icons) to train a model, export a model, and enable optional visualizations.

As another example, as illustrated in FIG. 9, the user may select inputs, such as the independent variables, the dependent variables. In some embodiments, the user may select Raman data (e.g., spectral data obtained via Raman spectroscopy) as the independent variable. Additionally or alternatively, the user may select the process variables as the independent variables and/or the dependent variables. Moreover, the user may select the number of components to project the data to and/or to perform training. As such, the user interface may enable the user to access data elements made available via the data model management architecture 120 to efficiently modify a number of parameters of a respective ML training portal, define other ML training portals, and the like. Indeed, the user interface may present datasets and/or files continuously generated and/or stored as described above with respect to the data model management architecture 120. In this manner, the user interface may enable the user to invoke and/or study various AI modeling operations.

At process block 192, the AI modeling system 68 may generate the selected AI model based on the training dataset files and the selected inputs. Thus, the selected AI model may be tailored to a particular project and/or particular user and employed to detect anomalies. Referring to FIG. 8, in some embodiments, the user may also select a visualization for Q-statistics, T²-statistics, a variance ratio plot, and/or a squared prediction error batch identification (ID). For example, as illustrated in FIG. 8, a first plot 212 may be representative of a Q-statistics plot for batch processing. The Q-statistics plot may include abnormal batches (e.g., outside expected statistical values), normal operation condition batches (e.g., within expected statistical values), and a threshold confidence interval (e.g., percentage). Thus, the first plot 212 may enable the user to visualize a number of Q-statistics for a number of batches. As another example, as illustrated in FIG. 8, a second plot 214 may be representative of a T²-statistics plot and may include the abnormal batches, the normal operation condition batches, and the threshold confidence interval to visualize a number of T²-statistics for the number of batches.

The user may then export (e.g., output) the selected AI model to download a set of data generated by the AI modeling system 68 onto a platform (e.g., infrastructure, environment) of the user based on the generated selected AI model. Alternatively, referring to FIG. 9, the user may select a visualization of a Raman spectrum 222 based on the generated selected AI model. In this manner, the AI modeling system 68 may present a visualization of a process variable correlation plot, which may include a fitting curve for each selected process variable. Moreover, the visualization may include a selected PLS component versus a root-mean-square (RMS) plot.

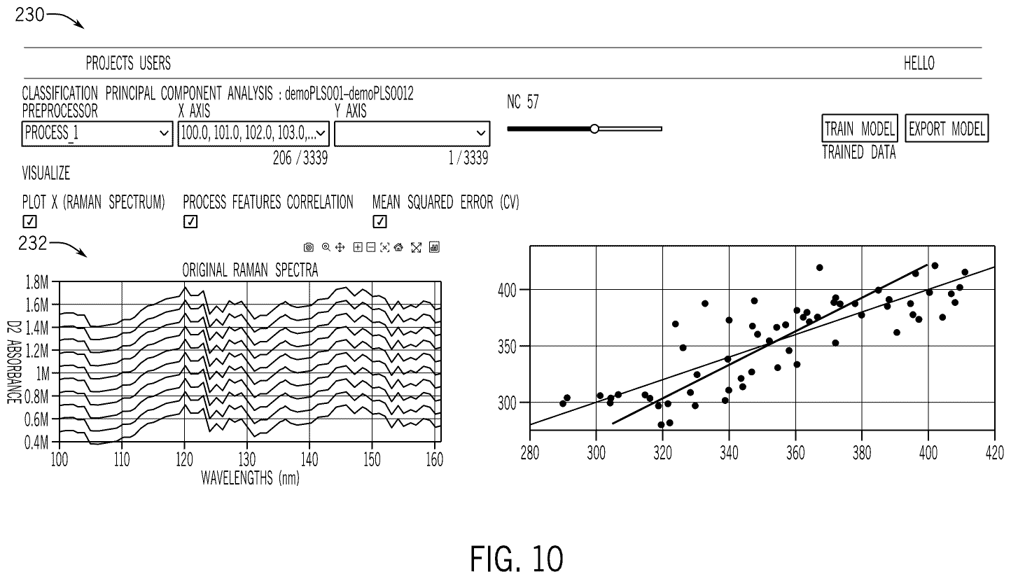

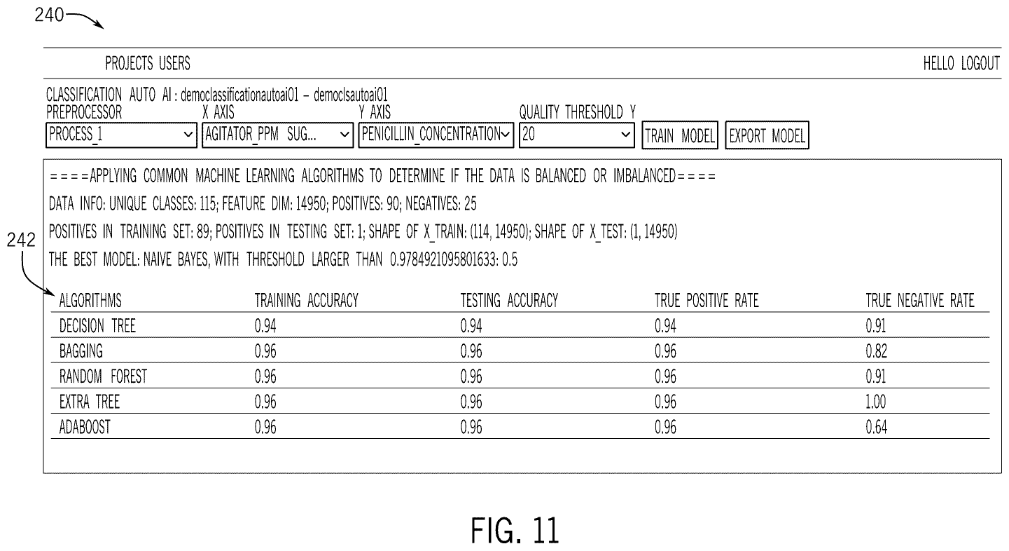

It should be noted that while the PCA Semi-Supervised Classification Model Training Portal user interface 210 of FIG. 8 and the PLS Regression Model Training Portal user interface 220 are described herein, any suitable user interface associated with any suitable model training portal may be presented to the user via the AI modeling system 68. For example, FIG. 10 is an illustration of a user interface 230 for modifying one or more parameters of an Automated AI (AutoAI) Regression Model Training Portal, in accordance with an embodiment. Additionally, FIG. 11 is an illustration of a user interface 240 for modifying one or more parameters of an AutoAI Classification Training Portal, in accordance with an embodiment. Referring to FIG. 10, the user interface 230 for the AutoAI Regression Model Training Portal may enable the user to select inputs, such as the independent variables (e.g., model independent variables selected from the process variables), the dependent variables (e.g., a continuous dependent target variable selected from the process variables), and the like via the user interface 230. Moreover, the threshold may be set for the continuous value of the dependent variable to discrete values and perform a respective classification. After receiving the selection of inputs, the AI modeling system 68 may output a Raman spectrum 232, the process variable correlation plot, and/or the model fitting curve for the selected process variables.

With reference to FIG. 11, the user interface 240 for the AutoAI Classification Training Portal may enable the user to select inputs, such as the independent variables, the dependent variables, a threshold for a target variable that transforms the target variable to one or more discrete values (e.g., healthy vs. unhealthy conditions) for classification training, and the like, via the user interface 240. After receiving the selection of inputs, the AI modeling system 68 may output one or more performances of a library of candidate supervisor ML algorithms, an optimal ML model for classifying data, input data information as output, and the like. Further, the AI modeling system 68 may output a table of data including types of algorithms, training accuracy, testing accuracy, a true positive rate, a true negative rate, and the like.

Accordingly, the AI modeling system 68 may provide access to models, raw data, or any other suitable file (e.g., indicated above) to enable the user to perform real-time testing and/or analysis for determining the quality of a number of batches, to detect anomalies, and the like. Moreover, the user may calibrate various ML training portals for different types of batch processing systems without creating new ML models and/or new training portals through use of the data, the ML training models, the modification of parameters for the ML training portals, and the like. As a result, the present embodiments described herein improve the operations of the computing system that may implement the AI modeling system 68 by efficiently updating ML models, as opposed to creating new ones. Further, the technology area related to batch processing using ML models is also improved by iteratively modifying variables of ML models that have been used or been useful in previous systems, thereby allowing a user to identify improved operations for the batch processes.

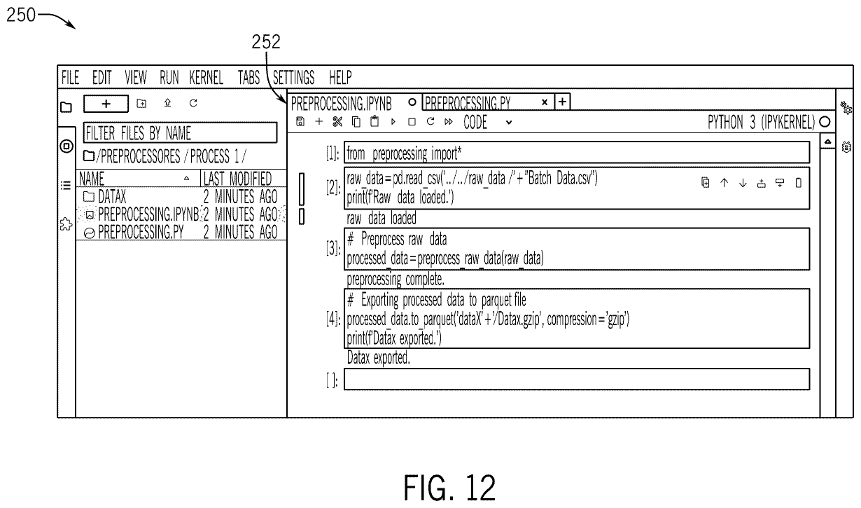

In addition to providing user interfaces (e.g., the user interface 210, the user interface 220, the user interface 230, and the user interface 240) for modifying ML parameters, the AI modeling system 68 may provide user interfaces for modifying pre-processing parameters employed in model training. As described herein, prior to training the model in the ML training portal, the AI modeling system 68 may pre-process the raw data using various methods. The AI modeling system 68 may provide the user interface for modifying the pre-processing parameters to enable the user to modify the pre-processing parameters with minimal coding efforts (e.g., related to pre-processing efforts). By way of example, FIGS. 12, 13, and 14 provide sample user interface visualizations that the user may employ (e.g., use) to minimize coding tasks related to pre-processing efforts.

In particular, FIG. 12 is an illustration of a user interface 250 for a pre-procession code editor 252, in accordance with an embodiment. As described herein, the AI modeling system 68 may use the pre-processing files 128 to pre-process the data 122 and generate the training data set files for the respective modeling technique 126. At times, a user may clean and/or organize the data 122 to conform to a structure employed by any suitable ML training portal using the pre-procession code editor 252. Further, the pre-procession code editor 252 may be embedded with an interactive development environment, such as Jupyter lab, to enable the user to create and/or manage pre-procession code, visualizations, text, and the like to handle pre-processing of the data 122. For example, a Python code may result from use of Jupyter lab by the user, which may be saved by the AI modeling system 68 and/or retrieved for reuse for one or more future datasets with a similar resource and/or data format. In this way, a user may dynamically modify or adjust the pre-processing operations for the respective batch process analysis.

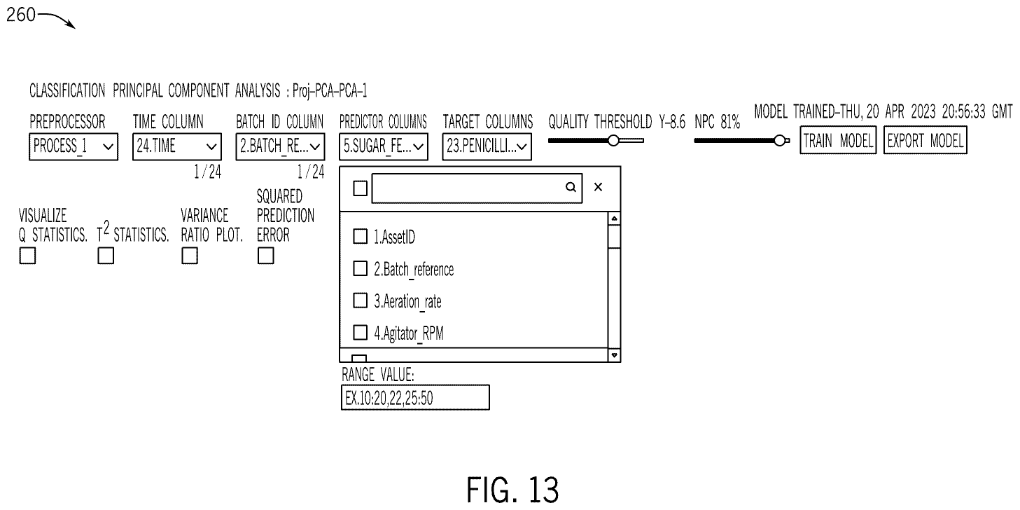

As another example, FIG. 13 is an illustration of predictor data and target data selection user interface 260, in accordance with an embodiment. The predictor data set and the target data set may be provided as two separate and distinct sets. For example, when employing a respective ML model, a selected independent variable may not be the same as a selected dependent variable. Indeed, the selected independent variable may be exclusive from the selected dependent variable. Further, the predictor data and target data selection user interface 260 may enable a data selection function to automatically handle unfolding (e.g., transforming, reshaping) of three-dimensional (3D) data.

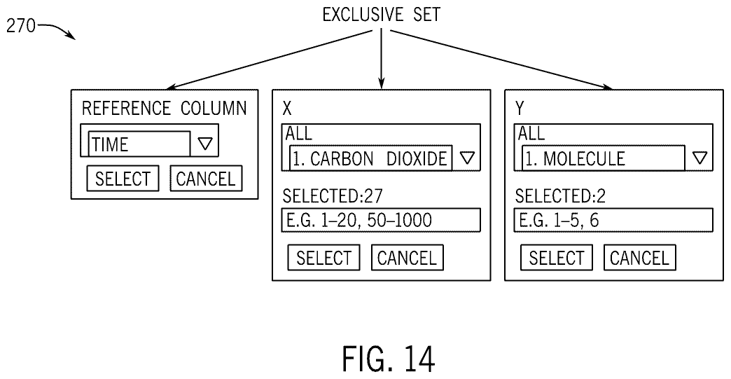

FIG. 14 is an illustration of a range selection user interface 270, in accordance with an embodiment. The range selection user interface 270 may enable the user to select a number of columns for the independent variables (e.g., x) and an associated range for the independent variables. Further, the range selection user interface 270 may enable the user to select a number of columns for the dependent variables (e.g., y) and an associated range for the dependent variables. The range selection user interface 270 may accommodate continuous data columns and/or discrete data columns. For example, the user may select a continuous range from 1 to 50. As another example, the user may select the continuous range from 1 to 1,000. The range selection user interface 270 may enable the user to narrow (e.g., refine, reduce) a large number (e.g., hundreds, thousands) of process variables that may be presented to the user. In this manner, a drop-down menu for selection of the independent variables and/or the dependent variables, such as examples presented in the user interfaces of FIGS. 8-11, may be presented to the user in a more compact and accessible format based on the selected ranges. It should be noted that the examples and illustrations provided in FIGS. 8-14 are merely illustrative and any suitable parameter may be adjusted and any suitable type of data may be presented to the user.

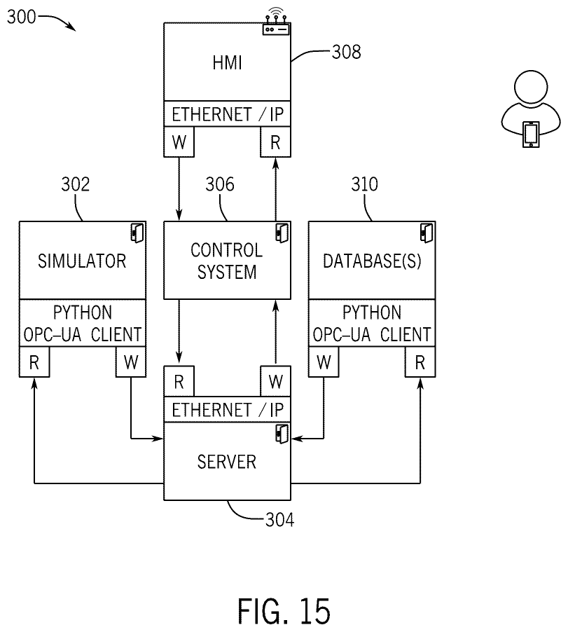

Keeping this in mind, embodiments described herein may enable real-time monitoring of data, while maintaining a connection between the IT data and the OT data. The data may be obtained in real-time via simulators and/or physical systems in the real world. With the foregoing in mind, FIG. 15 is an illustration of a batch processing system 300 that utilizes edge-deployed trained models for real-time monitoring, in accordance with an embodiment. In some embodiments, the batch processing system 300 may be associated with and/or a part of the industrial automation system 46. The batch processing system 300 may include a number of components or systems that work together to utilize the generated AI models (e.g., as described above with respect to FIGS. 5 and 6) for real-time monitoring and anomaly detection.

As illustrated in FIG. 15, the batch processing system 300 may include a simulator 302, a server device 304 (e.g., via a Unified Architecture (UA) Open Platform Communication (OPC) server), a control system 306 (e.g., Programmable Logic Controller (PLC), an Echo PLC), a Human-Machine Interface (HMI) 308 (e.g., Optix HMI), and/or one or more databases 310 (e.g., the ML models). In some embodiments, the simulator 302 may replicate conditions of a physical system in a controlled environment and transmit (e.g., write) various types of data (e.g., raw data) to the server device 304, which provides the various types of data to the control system 306. The server device 304 may communicate with the control system 306 via an EtherNet/Industrial Protocol (IP) or any suitable industrial or non-industrial protocol. In other embodiments, the control system 306 may receive data via the physical system, such as via a physical sensor or feedback mechanism that is a part of the physical system. As an example, the simulator 302 may include a simulated bioreactor system that transmits data, such as measurements of temperature, oxygen concentration, agitation speed, and the like.

In some embodiments, the databases 310 may store the predictive models 310 (e.g., on-premises), such that the control system 306 may use the data acquired from the simulator 302 to generate prediction data, in accordance with the embodiments described above. That is, the control system 306 may utilize the predictive models stored in the databases 310 with the data from the simulator 302 and generate the prediction data. The control system 306 may then transmit the prediction data to the server device 304. In some embodiments, the control system 306 may access a data center (e.g., centralized data center, data reservoir) for collecting, processing, storing, and/or distributing the data and the prediction data received from the simulator 302 and/or any suitable physical system, the server device 304, the HMI 308, and/or the database 310.

The HMI 308 may include a visualization tool, which may enable collection of both the data and the prediction data from the control system 306 and present the collection to the user via a visualization (e.g., visual format). For example, the HMI 308 may generate and present visualizations for specifying (e.g., adjusting) ML model parameters, pre-processing parameters, and the like as described above with respect to FIGS. 8-14. Additionally, the HMI 308 may include a command module, which may enable the user to modify operational parameters of the simulator 302. Indeed, the user may start, stop, or pause the simulator 302 via the command module. Moreover, the user may adjust a data generation rate of the simulator 302 via the command module. For example, the user may decrease the data generation rate to reduce the speed of data generation by the simulator 302. It should be noted that the HMI 308 may periodically collect the data and the prediction data from control system 306 to continuously update the visualizations presented to the user. In some embodiments, the HMI 308 may present visualizations generated in accordance with the embodiments described above and in FIGS. 8-14.

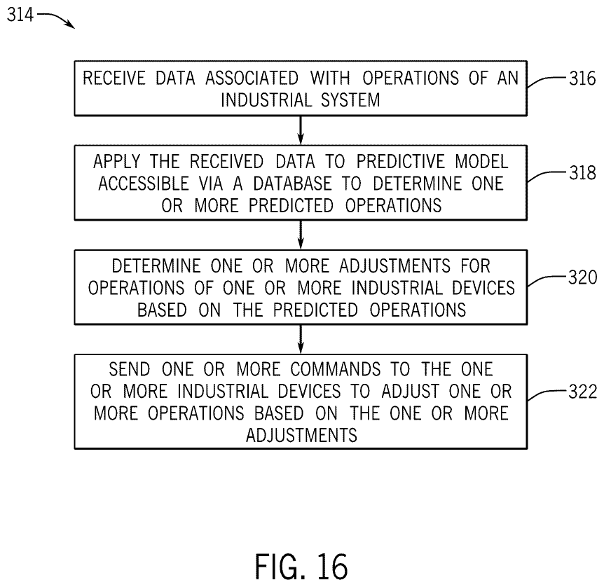

With the foregoing in mind, FIG. 16 is a flow chart of a method 314 for determining one or more adjustments for operations of one or more industrial devices based on predicted operations, in accordance with an embodiment. Although the following description of FIG. 16 is discussed as being performed by the control system 306, it should be understood that any suitable computing device may perform the method 314 in any suitable order.

Referring to FIG. 6, at process block 316, the control system 306 may receive data associated with operations of an industrial system (e.g., the industrial automation system 46). For example, in some embodiments, the simulator 302 may be a real industrial system (e.g., bioreactor system 10) that provides data to the control system 306 related to their respective operations. As such, the data associated with the operations of the industrial system may be provided directly to the control system 306, via the server device 304, and the like. At process block 318, the control system 306, in turn, may apply the received data to a predictive model accessible via the database 310 to determine one or more predicted operations. In some embodiments, the control system 306 may receive user inputs in accordance with the method 150 and/or the method 180 to generate an AI model for predicted operations of the respective industrial system. At process block 320, the control system 306 may determine one or more adjustments for operations of one or more industrial devices based on the predicted operations determined based on the predictive model (or the AI model). Further, at process block 322, the control system 306 may send commands to the one or more industrial devices to adjust their operations accordingly based on the one or more determined adjustments to improve efficiency, avoid anomalous conditions, and the like.

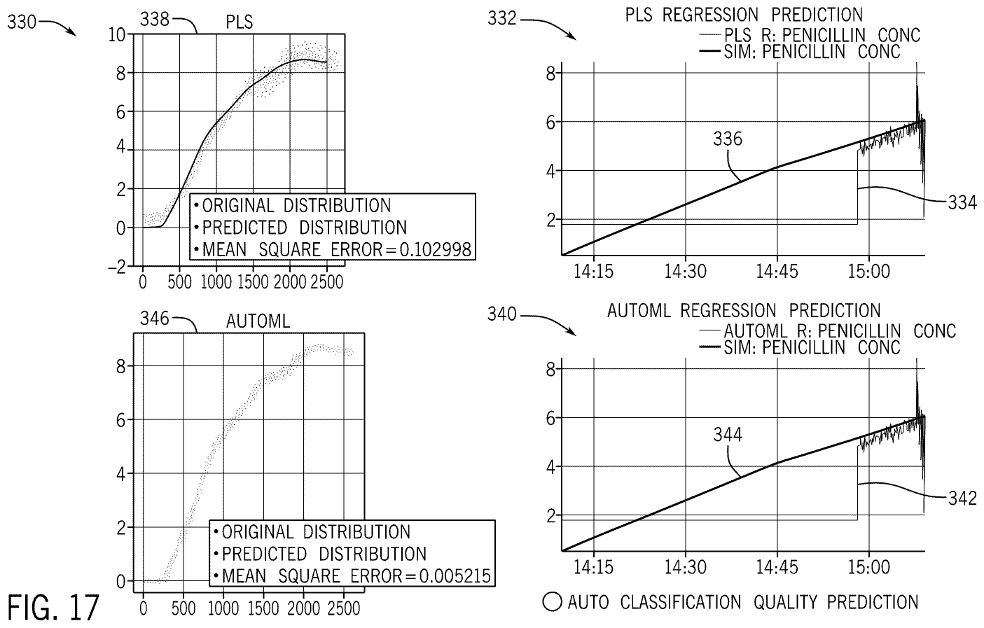

As described herein, after collecting the data from control system 306, the HMI 308 may present the visualization to the user based on the data. FIG. 17 is an example illustration of a prediction visualization user interface 330 for the HMI 308. A first plot 332 may include a PLS Regression Prediction plot. The PLS Regression Prediction Plot may demonstrate a first line 334 associated with the PLS Regression Prediction (e.g., a predicted value) and a second line 336 associated with the simulator 302 (e.g., an expected value). For example, the first line 334 may be associated with a predicted penicillin concentration and the second line 336 may be associated with an expected penicillin concentration over an amount of time (e.g., timeline, time series). Additionally, a second plot 338 may enable a visualization of an original distribution, a predicted distribution, and a mean squared error value for the PLS Regression Model. For example, as illustrated in FIG. 17, the mean squared error for the PLS Regression Model may be equal to 0.102998. Further, as illustrated in the second plot 338 the original distribution may overlap or almost overlap with the predicted distribution, which may indicate the predictions of the PLS Regression Model may be consistent with the data from the simulator 302.

Additionally or alternatively, as another example, a third plot 340 may include an AutoML Regression Prediction Plot. The AutoML Regression Prediction Plot may demonstrate a first line 342 associated with the AutoML Regression Prediction and a second line 344 associated with the simulator 302. For example, the first line 342 may be associated with the predicted penicillin concentration and the second line 344 may be associated with the expected penicillin concentration over the amount of time. Moreover, a fourth plot 346 may enable visualization of the original distribution, the predicted distribution, and the mean squared error value for the AutoML Regression Model. For example, as illustrated in FIG. 17, the mean squared error value for the AutoML Regression Model may be equal to 0.005215. The mean squared error value for the AutoML Regression Model is less than the mean squared error value for PLS Regression Model, which may indicate to the user that the AutoML Regression Model may be more accurate than the PLS Regression Model.

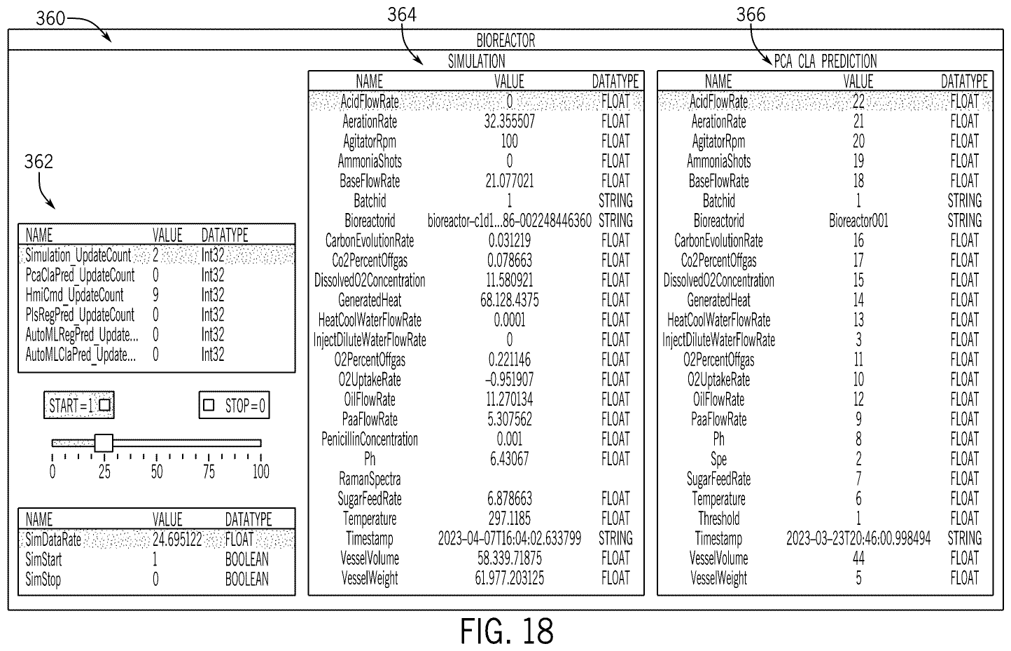

The HMI 308 may also provide a visualization to the user that includes additional data and/or associated controls related to the simulator 302, a particular predictive model, and the like. FIG. 18 is an illustration of an operational control user interface 360 for the HMI 308, in accordance with an embodiment. For example, the operational control user interface 360 may be associated with a bioreactor. The operational control user interface 360 may include a user command module 362, which may enable the user to start the simulator 302, stop the simulator 302, pause the simulator 302, and/or change the data generation rate (e.g., via a slider). When the simulator 302 and/or the predictive model 310 updates a record in the PLC 306, an associated update count may increment. Similarly, the update count may increment based on a change in a command.

The operational control user interface 360 may also include a first table 364, which may include data (e.g., raw data) received via the simulator 302 (e.g., the bioreactor simulator). Moreover, the operational control user interface 360 may include a second table 366, which may include data associated with a PCA Classification Prediction Model. The PCA Classification Prediction Model may be utilized to reduce an amount of raw data, such as to reduce the raw data to a particular number of features and/or to quantify a contribution of each of the number of features. Thus, the first table 364 and the second table 366 may enable the user to efficiently visualize, make decisions, and/or adjust parameters based on the data received via the simulator 302 and the data associated with the PCA Classification Prediction Model. As an example, the PCA Classification Prediction Model may be associated with a plot of data that indicates that a sugar feed rate contributes toward error by a particular percentage (e.g., 80%). Therefore, the user may use that plot of data to make decisions and/or adjust the sugar feed rate to reduce the percentage of error.

As such, employing the embodiments described herein, a data model management architecture may be used to arrange the input and output data flowing into and out of the batch processing system 300, while maximizing the reuse of data used for various ML training portals and resulting AI models. The ML training portals may be implemented to receive a number of parameters and generate visual outputs to assist the users in determining a combination of input parameters for training the predictive models to be deployed. Further, enabling the users to adjust the parameters of the predictive models and/or the pre-processing files 128 employed may improve flexibility and/or precision in selecting independent and dependent variables for each of the predictive models. In addition, the integration of the predictive models and the real-time monitoring system may be developed using the AI modeling system 68 (e.g., an IT-OT platform), which may enable the raw data and the predictive data to be consumed and/or visualized during run time of the reactor system 10 or any other suitable system of the industrial automation system 46. Moreover, the AI modeling system 68 employed to generate and/or modify the predictive models 310 may provide a streamlined and user-friendly approach in adopting and interpreting AI based solutions. Further, by offering zero-to-minimal code solutions, the AI modeling system 68 reduces data duplication in storage and pre-processing, and reduces involvement of programming to develop analytical models. Even further, the AI modeling system 68 may enhance the user's ability to make decisions related to anomaly detection in manufacturing processes for the user.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
industrial automation equipment of an industrial system;
a processing system comprising a memory, the memory encoded with instructions configured to be executed by the processing system to cause the processing system to perform operations comprising:
receiving data associated with the industrial automation equipment;
pre-processing the data using one or more pre-processing files associated with a modeling technique to generate pre-processed data;
generating one or more training dataset files based on the pre-processed data, wherein the one or more training dataset files are representative of one or more operational characteristics of the industrial automation equipment over time;
generating a model representative of one or more expected operations of the industrial automation equipment based on the one or more training dataset files;
storing the one or more training dataset files and an association between the one or more training dataset files with the modeling technique, the industrial automation equipment, or both in a database;
receiving a request to generate an additional model representative of one or more additional expected operations of additional industrial automation equipment of an additional industrial system different from the industrial system;
receiving additional data associated with the additional industrial automation equipment;
retrieving the one or more training dataset files based on the additional data; and
generating the additional model based on the one or more training dataset files and the additional data.

2. The system of claim 1, wherein the operations for storing the one or more training dataset files in the database comprises organizing the one or more training dataset files according to the modeling technique, one or more data transformations performed on the data based on the one or more pre-processing files, or both.

3. The system of claim 1, wherein the operations further comprise storing the one or more training dataset files based on a type of the industrial automation equipment, a type of industry of the industrial system, a geographical region of the industrial system, or any combination thereof.

4. The system of claim 3, wherein the operations further comprise:
determining an additional association between the additional industrial automation equipment and the industrial automation equipment; and
identifying the one or more training dataset files based on the additional association.

5. The system of claim 1, wherein the modeling technique comprises a Multi-Variable Data Analysis model, a Supervised Classification model, or a Supervised Regression model.

6. The system of claim 1, wherein the data comprises operational data associated with the industrial system, environmental data associated with the industrial system, energy consumption data associated with the industrial system, historical data associated with the industrial system, or any combination thereof.

7. The system of claim 1, wherein the one or more training dataset files comprise a Python file, a pickle file, a Jupyter Notebook file, a comma-separated values file, a metadata file, or any combination thereof.

8. The system of claim 1, wherein the operations comprise:
performing a simulation of the one or more expected operations of the industrial automation equipment to determine one or more anomalies based on the model; and
adjusting one or more additional operations of respective industrial automation equipment based on the one or more anomalies.

9. The system of claim 8, wherein the operations further comprise activating a backup device, providing a notification comprising the one or more anomalies, or any combination thereof.

10. The system of claim 1, wherein the industrial automation equipment comprises one or more information technology (IT) devices, one or more operational technology (OT) devices, or both.

11. A non-transitory, tangible, computer-readable medium storing instructions that, when executed by processing circuitry, cause the processing circuitry to perform operations comprising:
receiving data associated with industrial automation equipment of an industrial system;
pre-processing the data using one or more pre-processing files associated with a modeling technique to generate pre-processed data;
generating one or more training dataset files based on the pre-processed data, wherein the one or more training dataset files are representative of one or more operational characteristics of the industrial automation equipment over time;
generating a model representative of one or more expected operations of the industrial automation equipment based on the training dataset files;
storing the one or more training dataset files and an association between the one or more training dataset files with the modeling technique, the industrial automation equipment, or both in a database;
receiving a request to generate an additional model representative of one or more additional expected operations of additional industrial automation equipment of an additional industrial system different from the industrial system;
receiving additional data associated with the additional industrial automation equipment;
retrieving the one or more training dataset files based on the additional data; and
generating the additional model based on the one or more training dataset files and the additional data.

12. The non-transitory, tangible, computer-readable medium of claim 11, wherein the instructions cause the processing circuitry to perform operations for storing the one or more training dataset files in the database comprises organizing the one or more training dataset files according to the modeling technique, one or more data transformations performed on the data based on the one or more pre-processing files, or both.

13. The non-transitory, tangible, computer-readable medium of claim 11, wherein the instructions cause the processing circuitry to perform operations comprising storing the one or more training dataset files based on a type of the industrial automation equipment, a type of industry of the industrial system, a geographical region of the industrial system, or any combination thereof.

14. The non-transitory, tangible, computer-readable medium of claim 11, wherein the modeling technique comprises a Multi-Variable Data Analysis model, a Supervised Classification model, or a Supervised Regression model.

15. The non-transitory, tangible, computer-readable medium of claim 11, wherein the instructions cause the processing circuitry to perform operations comprising:
performing a simulation of expected operations of the industrial automation equipment to determine one or more anomalies based on the model; and
adjusting one or more additional operations of respective industrial automation equipment based on the one or more anomalies.

16. A method comprising:
receiving, via processing circuitry, data associated with industrial automation equipment of an industrial system;
pre-processing, via the processing circuitry, the data using one or more pre-processing files associated with a modeling technique to generate pre-processed data;
generating, via the processing circuitry, one or more training dataset files based on the pre-processed data, wherein the one or more training dataset files are representative of one or more operational characteristics of the industrial automation equipment over time;
generating, via the processing circuitry, a model representative of one or more expected operations of the industrial automation equipment based on the training dataset files;
storing, via the processing circuitry, the one or more training dataset files and an association between the one or more training dataset files with the modeling technique, the industrial automation equipment, or both in a database;
receiving, via the processing circuitry, a request to generate an additional model representative of one or more additional expected operations of additional industrial automation equipment of an additional industrial system different from the industrial system;
receiving, via the processing circuitry, additional data associated with the additional industrial automation equipment;
retrieving, via the processing circuitry, the one or more training dataset files based on the additional data; and
generating, via the processing circuitry, the additional model based on the one or more training dataset files and the additional data.

17. The method of claim 16, comprising storing, via the processing circuitry the one or more training dataset files in the database comprises organizing the one or more training dataset files according to the modeling technique, one or more data transformations performed on the data based on the one or more pre-processing files, or both.

18. The method of claim 16, comprising storing, via the processing circuitry, the one or more training dataset files based on a type of the industrial automation equipment, a type of industry of the industrial system, a geographical region of the industrial system, or any combination thereof.

19. The method of claim 18, wherein the data comprises operational data associated with the industrial system, environmental data associated with the industrial system, energy consumption data associated with the industrial system, historical data associated with the industrial system, or any combination thereof.

20. The method of claim 16, wherein the industrial automation equipment comprises one or more information technology (IT) devices, one or more operational technology (OT) devices, or both.
